(19) United States
(12) Patent Application Publication
(10) Pub. No.: US 2025/0274736 A1
(43) Pub. Date: Aug. 28, 2025

(54) SYSTEM AND METHOD OF DEVICE DETECTION

(71) Applicant: FARM HEALTH GUARDIAN LTD., Guelph (CA)

(72) Inventors: Idris SOULE ALAOFE, Guelph (CA); Timothy NELSON, Guelph (CA); Xiaodong LIN, Guelph (ON); Le WANG, Guelph (ON)

(21) Appl. No.: 18/857,564

(22) PCT Filed: Apr. 19, 2023
(86) PCT No.: PCT/CA2023/050528

§ 371 Date: Oct. 17, 2024

Related U.S. Application Data
(60) Provisional application No. 63/332,517, filed on Apr. 19, 2022.

(51) Int. Cl. H04W 8/00; H04W 8/22; H04W 64/00; H04W 68/02; H04W 76/20

(52) U.S. Cl. CPC H04W 8/005; H04W 8/22; H04W 64/00; H04W 68/02; H04W 76/20

(57) ABSTRACT

A system and method of detecting mobile devices is provided. The method comprises a processor sending a soft page message via MSISDN to an MME, tracking at least one of a TMSI, S-TMSI, GUTI, or c-RNTI, and receiving a P-RNTI filtering message from an eNB. A system and method of classifying detected mobile devices is also provided. The method comprises listening on an uplink channel for a detected mobile device, receiving from the detected mobile device capabilities information regarding the detected mobile device, and obtaining a UE model of the detected mobile device where the UE model is determined based on the capabilities information.

### FIELD

The present disclosure generally relates to detection, and in particular to a system and method of detecting mobile devices in a geo-fenced area.

### INTRODUCTION

Livestock and poultry farms use biosecurity programs to detect and control authorized access to the property. Such biosecurity programs are intended to detect intruders and/or biohazards entering the property.

Some current methods that relate to detection of cellular presence analyze the presence of key cellular frequencies but cannot guarantee a particular perimeter to guard among other issues. For different reasons both video surveillance and movement detectors do not provide adequate protection from intrusion into private property. Often, new/emerging systems, such as biometric scanning/screening, can be prohibitively expensive for agricultural use.

### SUMMARY

In accordance with an aspect, there is provided a system for detecting mobile devices is provided. The system comprises at least one processor and a memory storing instructions which when executed by the at least one processor cause the at least one processor to: send a soft page message via MSISDN to an MME, track at least one of a TMSI, S-TMSI, GUTI, or c-RNTI, and send a P-RNTI filtering message to an eNB.

In accordance with an aspect, there is provided a method of detecting mobile devices is provided. The method comprises a processor sending a soft page message via MSISDN to an MME, tracking at least one of a TMSI, S-TMSI, GUTI, or c-RNTI, and sending a P-RNTI filtering message to an eNB.

In accordance with another aspect, there is provided a system for classifying detected mobile devices is also provided. The system comprises at least one processor and a memory storing instructions which when executed by the at least one processor cause the at least one processor to: listen on an uplink channel for a detected mobile device, receive from the detected mobile device capabilities information regarding the detected mobile device, and obtain a UE model of the detected mobile device where the UE model is determined based on the capabilities information.

In accordance with another aspect, there is provided a method of classifying detected mobile devices is also provided. The method comprises listening on an uplink channel for a detected mobile device, receiving from the detected mobile device capabilities information regarding the detected mobile device, and obtaining a UE model of the detected mobile device where the UE model is determined based on the capabilities information.

In various further aspects, the disclosure provides corresponding systems and devices, and logic structures such as machine-executable coded instruction sets for implementing such systems, devices, and methods.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will appear to those skilled in the art following a reading of the instant disclosure.

### DESCRIPTION OF THE FIGURES

Embodiments will be described, by way of example only, with reference to the attached figures, wherein in the figures:

FIG. 1 illustrates, in a component diagram, an example of an environment for locating and detecting UEs on properties, in accordance with some embodiments;

FIG. 2 illustrates, in a flowchart, an example of paging initiated by an MME or eNB on S1-MME or UU, in accordance with some embodiments;

FIG. 3 illustrates, in a call flow diagram, an example of soft paging, in accordance with some embodiments;

FIG. 4 illustrates an example of DRX modes in a network architecture, in accordance with some embodiments;

FIG. 5 illustrates an example of DRX states in RRC connected/idle modes, in accordance with some embodiments;

FIG. 6 illustrates, in a call flow diagram, an example of a method of determining a UE model, in accordance with some embodiments;

FIG. 7 illustrates an example of a machine learning method of determining a UE model, in accordance with some embodiments;

FIG. 8 illustrates an example of determining UE localization, in accordance with some embodiments; and

FIG. 9 is a schematic diagram of a computing device such as a server or other computer.

It is understood that throughout the description and figures, like features are identified by like reference numerals.

### DETAILED DESCRIPTION

Embodiments of methods, systems, and apparatus are described through reference to the drawings. Applicant notes that the described embodiments and examples are illustrative and non-limiting. Practical implementation of the features may incorporate a combination of some or all of the aspects, and features described herein should not be taken as indications of future or existing product plans.

In some embodiments, there is provided a biosecurity system and method to detect the presence of unauthorized people (e.g., trespassers) on properties (e.g., farms).

In some embodiments, a passive Radio Frequency (RF) system, for monitoring, detecting and locating Long-Term Evolution (LTE)/Fifth Generation (5G) devices in a geo-fenced area is provided. By principle, the system leverages flaws or “features” of the 3rd Generation Partnership Project (3GPP) protocols without compromising the integrity and encryption of messages exchanged between cellular devices and mobile base-station.

LTE systems operate through bi-directional communication of a base station or cell tower (e.g., eNodeB) and user equipment (UE) (e.g., a cellular device) over the air. A cell is a physical location containing one or more eNodeB's in a tracking area. Once a UE synchronizes and attaches to an eNodeB with the strongest signal in the area, messages in the form of a Short Message Service (SMS) message or phone calls can be relayed to the UE. Each UE has a global unique identifier, termed an International Mobile Subscriber Identity (IMSI). The IMSI should be secured since it exposes the user to various attack vectors. As such, a temporary pseudonym, Temporary Mobile Subscriber Identity (TMSI)/Serving TMSI (S-TMSI)/Globally Unique Temporary UE Identity (GUTI)/cell Radio Network Temporary Identifier (c-RNTI), is used in the exchange of messages between the eNodeB and UE (TMSI/S-TMSI for 3G or GUTI for LTE UEs or c-RNTI for 3G, LTE and 5G).

In some embodiments, a system is provided that operates by continuously monitoring the frequencies of eNodeB's in a cell, which serves the area under protection. Messages exchanged in the clear (unencrypted messages) are retrieved by the system, deconstructed and analyzed. The system monitors for GUTI/TMSI/S-TMSI/c-RNTI in network packets in order to understand: i) the amount of users camping on a cell tower, and ii) their time of entry and possible exit. The system is then effectively able to passively track TMSI's/S-TMSI's/GUTI's/c-RNTI's within a geofence, through proprietary temporal, spatial and context linking RF techniques. In the event of selective frequency jamming, the system is able to quickly mitigate. Furthermore, the system may be configures to whitelist cellular devices that are not seen as a threat, such as an owner on premise (e.g., Farm Health Guardian™ users) and blacklist unknown or threating cellular devices.

The following technologies may be utilized as part of an overall system:
Customized Software Defined Radios (SDR)
mmWave (millimeterWave) sensors
Field Programmable Gate Arrays (FPGAs)
Embedded micro-controllers
Spectrum analyzers

In some embodiments, there are different aspects to the methods of this system. For example:
The possible linkability of IMSI's and GUTI/TMSI/S-TMSI/c-RNTI on properties
Detection of whitelisted UEs presence based on a proprietary process
RF baseband signature classification
UE (mmWave) localization on FR1/2 for 5G-NR (New Radio)

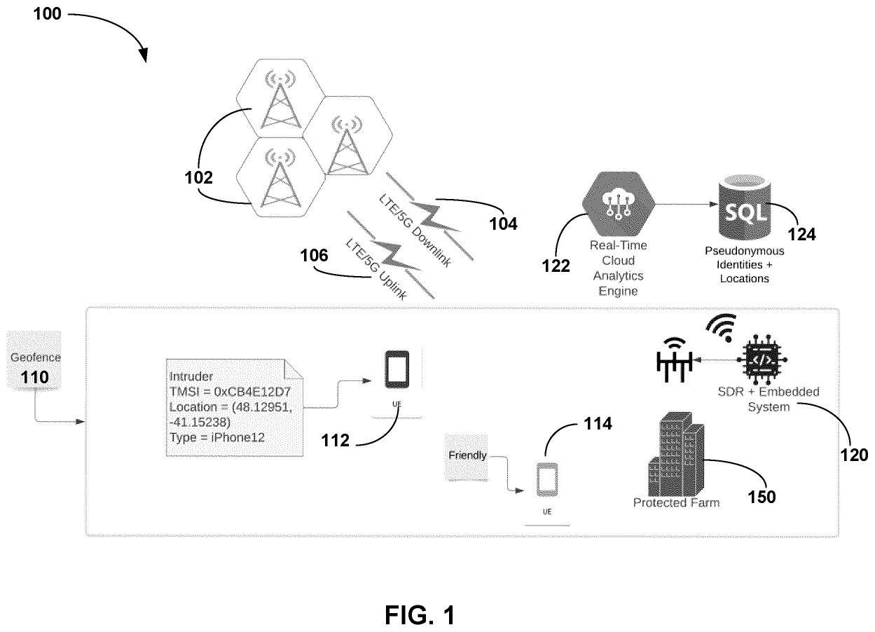

FIG. 1 illustrates, in a component diagram, an example of an environment 100 for locating and detecting UEs on properties 150, in accordance with some embodiments. The environment 100 comprises one or more eNodeB (eNB) 102 in communication with a software defined radio (SDR) and embedded system 120 via LTE/5G downlink 104 and uplink 106 signals, a geofence 110 around a property 150 within which there may be intruder UEs 112 or friendly UEs 114, and the system 120. The system 120 may be in communication with a real-time cloud analytics engine 122 which has access to a database (e.g., a SQL database) 124 storing pseudonymous identities and locations.

### Detection of Whitelisted UEs Presence Based on MSISDN Soft-Paging

In some embodiments, the system 120 is configured to account for UEs 112, 114 that are on the property, so as to not mistake them for intruders. The LTE paging protocol, application priority paging and smart paging may be used to ensure UEs registered or allowed are not to be flagged during scanning of LTE channels. Furthermore, a known identity of allowed UEs may be used to ensure the system 120 does not mistake an allowed device for an intruder. The Mobile Station Integrated Services Digital Network (MSISDN) may be used, which is the UEs phone number, easily known or obtained by the owners on property.

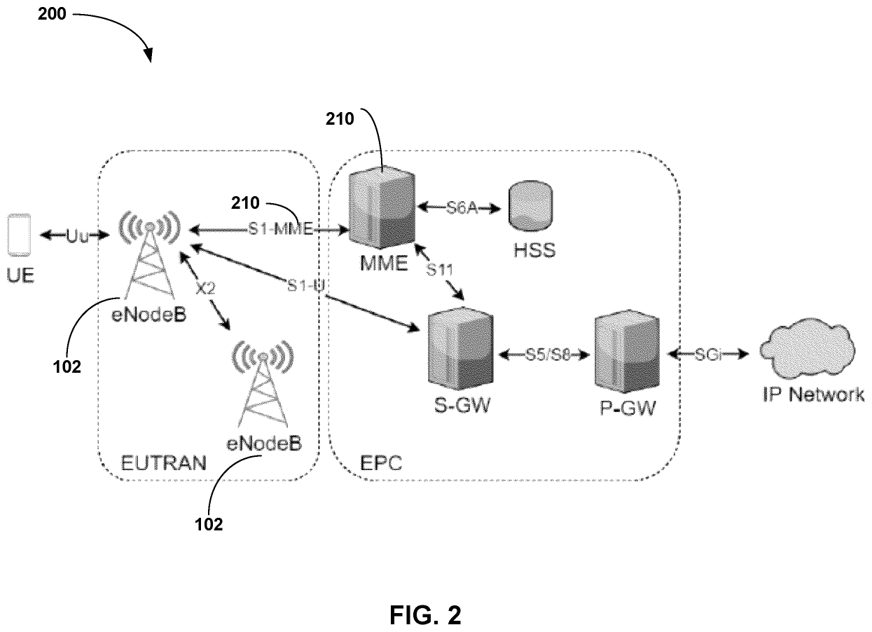

FIG. 2 represents the canonical definition of a LTE network. FIG. 2 illustrates, in a flowchart, an example of paging 200 initiated by a Mobility Management Entity (MME) 210 or eNB 102 on S1-MME or UU, in accordance with some embodiments. Specifically, the system 120 observes paging messages originating from the MME 210 for UEs 112, 114 in the Tracking Area (e.g., approximate area defined by the geofence 110). With the aid of smart paging, the system 120 is ensured to prevent signalling storms on the S1-MME link 208. The determination of paging cycle and other SIB2 paging parameters are not required in some embodiments.

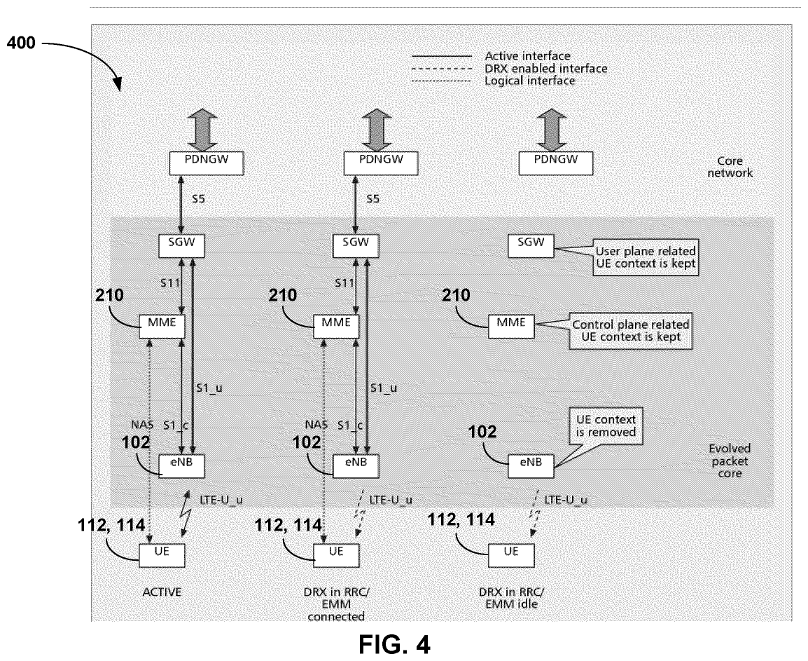

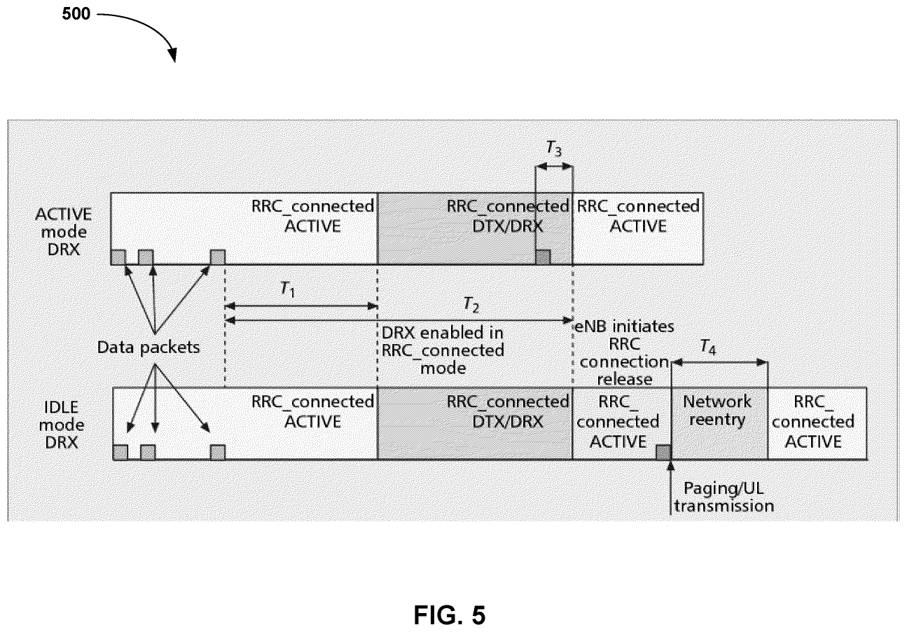

By retrieving a database of whitelisted UEs 114, the system 120 can initiate what may be deemed as soft VOLTE calls or soft SMS. Soft paging is a presence test for each UE 112, 114 under service by a cell, typically the last cell it camped on if in DRX (Discontinuous Reception) under the Radio Resource Control (RRC) IDLE state (see FIGS. 4 and 5).

In some embodiments, system 120 interacts only with eNodeB 102 and the UE 112, 114. All other systems are internal to the network (e.g., LTE network).

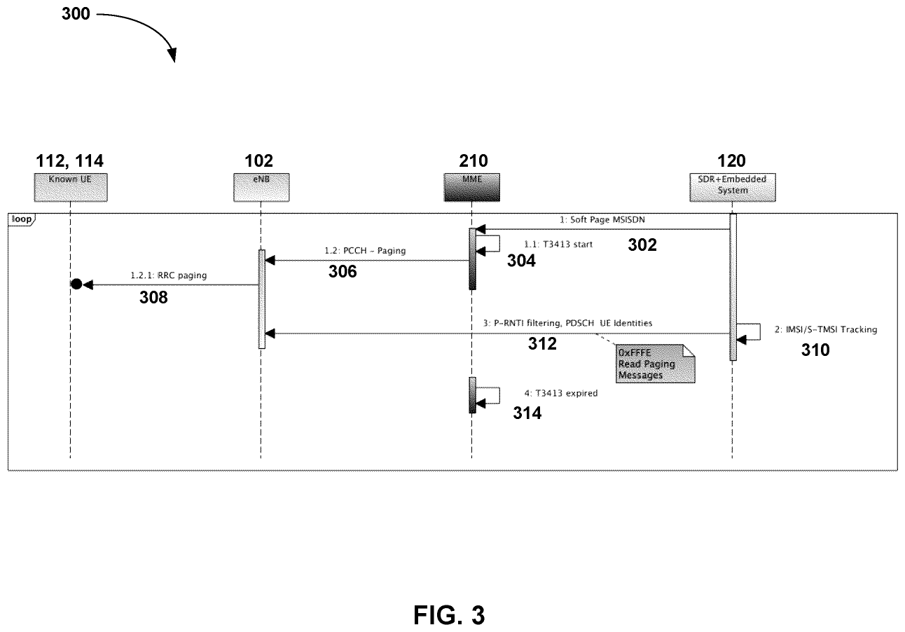

FIG. 3 illustrates, in a call flow diagram, an example of soft paging 300, in accordance with some embodiments. The system 120 sends a soft page message 302 via an MSISDN to an MME 210. The MME 210 initiates a T3413 timer 304 and sends a Paging Control Channel (PCCH)—paging message 306 to an eNB 102. The eNB 102 then sends an RRC paging message 308 to the known UE which does not trigger the UE 112, 114. I.e., trigger in the sense that the callee has no knowledge of the call being made to their UE via the display or notification method of said UE. Next, the system 120 initiates TMSI/S-TMSI/GUTI/c-RNTI tracking 310. Next the system 120 reads the PDSCH and performs P-RNTI filtering 312 that includes UE identities to the eNB 102. The T3413 then expires 314.

Once a paging message has propagated through the LTE architecture, system 120 reads the PDSCH and filters for paging message through the P-RNTI (Paging Radio Network Temporary Identifier). In each paging message, the system 120 checks for a reoccurring TMSI as it continues to soft page the MSISDN. Timer T3413 is an inactivity timer used by the MME in the event that there is no response to the paging message. When system 120 initiates the soft page it listens between the start and end of T3413 to ensure that the system 120 has the possibility to read paging messages (Note: read it too early and the system may have to wait a little while to see the message, read it too late and the message is gone).

The soft page is a term to denote the essence of system 120 calling (VOLTE) or texting (SMS) the known UE but “hanging” up: a) before the known UE can register the call, and b) within enough time to ensure the paging message is sent over the air.

FIG. 4 represents an interaction diagram between the canonical definition of a LTE network of FIG. 2 (including a server gateway (SGW), the MME 210, the eNB 102 and a UE 112, 114. FIG. 4 illustrates an example of DRX modes in a network architecture 400, in accordance with some embodiments. When the UE is not listening to the DL transmission, most of its circuitry is turned off. The UE battery saving depends on the DRX parameter settings. DRX parameters in this mode are provided by the eNB 102 during the radio bearer setup.

FIG. 4 shows the connection between the UE 112, 114 and eNB 102 during the various states. Specifically, the soft paging mechanism is applicable when the UE 112, 114 is in idle mode. There is no UE context as all connections have ceased because the UE is idle and is preserving battery life. Over the lifetime of monitoring the particular property, known UEs based on their MSISDN are going to be in the idle state allowing system 120 to successfully soft page the known UE.

FIG. 5 represents transitions of DRX states in a UE. FIG. 5 illustrates an example of DRX states in RRC connected/idle modes 500, in accordance with some embodiments. In some embodiments, the soft-page embedded system 120 comprises UE hardware and eSIM enabling it to perform the functions of an off-the-shelf UE, with the addition of accessing advanced engineer mode specifics. The system 120 will soft page so as to not cause the known UE 112, 114 to awake out of DRX or cause continuous alerts on the foreground of the UEs user interface. This mechanism is accomplished by starting and then stopping a UE terminated service before the aforementioned alert is on the UE. However, it should be long enough to pass over the air interface to the EPC. The MME 210 will start T3413, paging service request is sent to the eNB 102, the RRC paging message is not delivered to the UE. In doing so the UE does not respond after waking up out of DRX to check on the paging messages—i.e., there is no message in its slot. The system 120 may be configured to wait a given time window so as to ensure that the message is read. This process is repeated until the system 120 determines that there is a TMSI/S-TMSI/GUTI that is continuously seen in the paging messages. This TMSI/S-TMSI/GUTI can then be marked as safe within the system 120. In the event that the TMSI/S-TMSI/GUTI is not seen, the system 120 may assume that either the UE is not in the TA, or that the UE is engaged in a call. Depending on the initial setup tests, whether or not certain services cause GUTI/TMSI/S-TMSI re-allocations are checked, the service based on the implementation of the area under protection is varied.

The following is an example of a paging record with a UE identity that is a type S-TMSI (other paging records could apply to TMSI/GUTI):

PCCH-Message : := SEQUENCE

+-message : := CHOICE [c1]

+-c1 : := CHOICE [paging]

+-paging : := SEQUENCE [1000]

| +-pagingRecordList : := SEQUENCE OF SIZE(1..maxPageRec[16]) [1] OPTIONAL : Exist | | | | |
|---|---|---|---|---|
| \| | +-PagingRecord : := SEQUENCE | | | |
| \| | | +-ue-Identity : := CHOICE [s-TMSI] | | |
| \| | | \| | +-s-TMSI : := SEQUENCE | |
| \| | | \| | | +-mmec : := BIT STRING SIZE(8) [00000001] |
| \| | | \| | | +-m-TMSI : := BIT STRING SIZE(32) [00000000000000000000000000000001] |

| | |
|---|---|
| \| | +-cn-Domain : := ENUMERATED [ps] |

+-systemInfoModification : := ENUMERATED OPTIONAL : Omit
+-etws-Indication : := ENUMERATED OPTIONAL : Omit
+-nonCriticalExtension : := SEQUENCE OPTIONAL : Omit

### UE Baseband Signature Classification

The system 120 may utilize machine learning techniques to predict the model of a UE, via: UE capabilities and other uplink data sent in unencrypted channels. It should be noted that the UE capabilities are specific to both the make and model of the UE. The baseband in each phone model will have slight variations due to manufacturer design and implementation undefined function can be observed and modelled through the uu interface. Through supervised learning, a model may be trained to learn distinguishing features of a set of distinct UE. Trained sets may be stored in a database and when the system is live, UE capability information is queried from the database, and a resulting UE model is yielded.

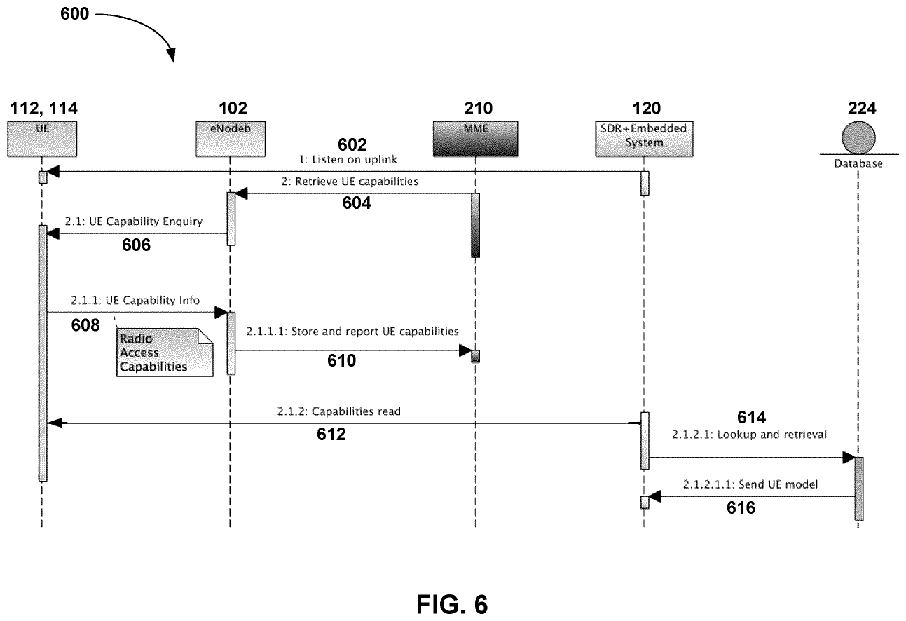

FIG. 6 illustrates, in a call flow diagram, an example of a method of determining a UE model 600, in accordance with some embodiments. The system 120 listens 302 on the uplink for a UE 112, 114. The MME 210 requests 304 UE capabilities from the eNB 102. The eNB 102 sends a UE capability enquiry message 606 to the UE 112, 114. The UE 112, 114 sends its UE capability information 608 to the eNB 102. The eNB 102 stores and reports 610 the UE capabilities to the MME 210. The system 120 then reads 612 the capabilities of the UE 112, 114. The system 120 then looks up and retrieves the UE model from the database 224 which in turn sends the UE model to the system 120.

System 120 monitors the uplink channel by listening to a particular frequency derived from a downlink E-UTRA Absolute Radio Frequency Channel Number (EARFCN) of the eNB(s) 102 serving the area under protection. The term listening refers to parsing various LTE based messages between the UE 112, 114 and eNB 102. System 120 does not connect with the UE 112, 114, the unencrypted messages exchanged over the air are monitored. Step 612 is a representation of system 120 also reading the UE capabilities when they are requested from the eNB 102. In some embodiments, the database 224 is trained for a large set of UEs currently used. Should a UE exhibit capabilities that are not detected in the trained model, it may detect something close or nothing at all. In this particular scenario, the model can later be trained (e.g., via online learning) with the new unseen capabilities configurations. The method shown in FIG. 6 may be used to gather additional information about a potential intruder and help shape the “image” or “signature” of an intruder.

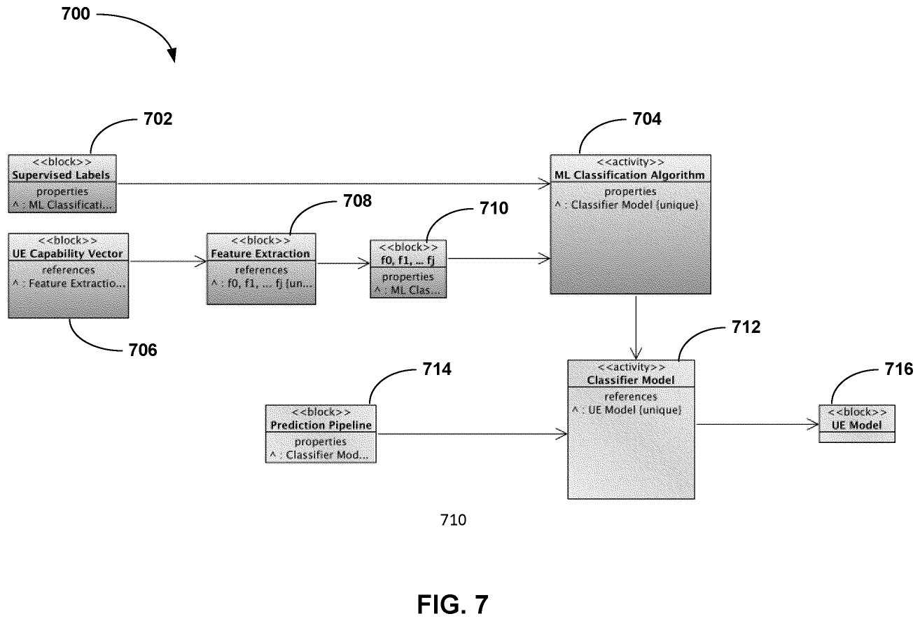

FIG. 7 illustrates an example of a machine learning method of determining a UE model 700, in accordance with some embodiments. A set of various popular UE models (consisting of phones and tablets), and various operating systems (IOS, Android based, Windows based, others) may be gathered. In order to facilitate retrieving the features of the UEs, they need to be determined by training the model(s). Through the use of a customized eNB in a testing facility the capabilities for each device model may be determined, which can be further tagged by baseband radio manufacturer and operating system. This is a supervised learning exercise where labels are given to each UE. The trained model roughly computes the probability of a given label given known capability information as an output which is anchored to a particular UE model.

Supervised Labels 702 are fed into a machine learning (ML) classification algorithm 704. A UE capability vector 706 specific to a make and model for a UE is fed into a feature extraction module 708. The feather extraction outputs a set of features (f0, f1, . . . fj) 710 unique to the UE which are then fed into the ML classification algorithm 704. The supervised labels 702 and set of features 710 are used by the ML classification algorithm 704 to generate a classifier model 712. Prediction pipeline 714 provides statistical modelling data for each make and model of UEs for the classifier model 712 to use to determine the probability of what make and model is being detected. The classifier model 712 generates an instantiated UE model 716 representing the make and model of the UE that is being detected.

LTE and 5G-NR Localization Aid with CSI, Timing Advance and mmWave+LIDAR

In some embodiments, UE localization aid in 4G/LTE may be achieved through the use of a fused solution to compensate for clock inefficiencies/errors, missed resource elements due to hardware inefficiencies, and counter-attack techniques of intruders. Furthermore for Fifth Generation mobile network (5G), a bifurcated system is provided due to low frequency bands (FR1) and high frequency bands (FR2). FR1 localization will use many of the concepts from Forth Generation (4G) and OTDOA, while FR2 will use mmWave technologies along with light detection and ranging (LIDAR).

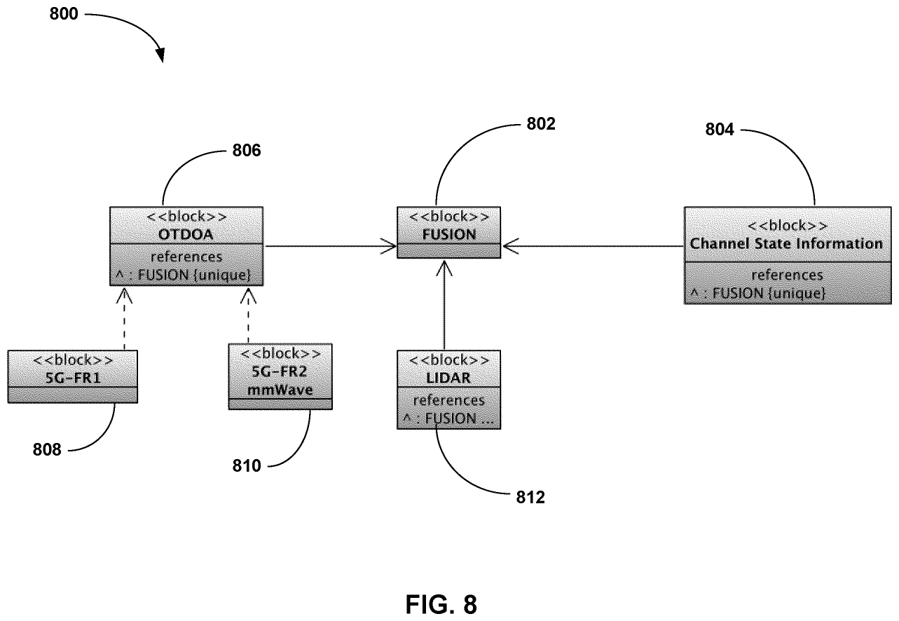

FIG. 8 illustrates an example of determining UE localization 800, in accordance with some embodiments. In areas where either 4G, 5G or both are present, a fused solution may take care of various UEs 112, 114 that may be on the property operating on different frequencies of the spectrum. Channel State Information 804 derived from the downlink along with other parameters may be used to improve position estimates of the UE 112, 114 on the property. As it relates to 5G, a modified OTDOA (Observed Time Difference of Arrival) 806 may be used that receives device and location data pertaining to low frequency bands of 5G-FR1 808 and/or device and location data pertaining to 5G-FR2 mmWave 810. Lidar and mmWave technologies 812 are similarly commissioned to improve position accuracy for 5G frequencies with FR2 (24.25-52.6 GHz). These location estimators may be fused together in a model 802 (via machine learning) to determine the UEs geolocation based on a pre-calculated cellular RF map.

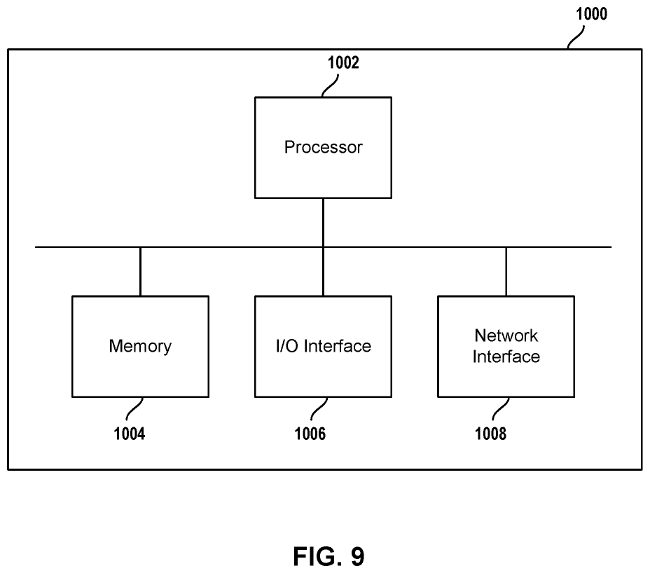

FIG. 9 is a schematic diagram of a computing device 1000 such as a server or other computer. As depicted, the computing device includes at least one processor 1002, memory 1004, at least one I/O interface 1006, and at least one network interface 1008.

Processor 1002 may be an Intel or AMD x86 or x64, PowerPC, ARM processor, or the like. Memory 1004 may include a suitable combination of computer memory that is located either internally or externally such as, for example, random-access memory (RAM), read-only memory (ROM), compact disc read-only memory (CDROM).

Each I/O interface 1006 enables computing device 1000 to interconnect with one or more input devices, such as a keyboard, mouse, camera, touch screen and a microphone, or with one or more output devices such as a display screen and a speaker.

Each network interface 1008 enables computing device 1000 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others.

The foregoing discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

Although the embodiments have been described in detail, it should be understood that various changes, substitutions and alterations can be made herein.

Moreover, the scope of the present application is not intended to be limited to the particular embodiments of the process, machine, manufacture, composition of matter, means, methods and steps described in the specification.

As can be understood, the examples described above and illustrated are intended to be exemplary only.

What is claimed is:

1. A system for detecting mobile devices, the system comprising:
at least one processor; and
a memory storing instructions which when executed by the at least one processor configure the at least one processor to:
send, by a processor, a soft page message via a Mobile Station Integrated Services Digital Network (MSISDN) to a Mobility Management Entity (MME);
track, by the processor, at least one of:
a Temporary Mobile Subscriber Identity (TMSI);
a Serving TMSI (S-TMSI);
a Globally Unique Temporary UE Identity (GUTI); or
a cell Radio Network Temporary Identifier (c-RNTI); and
send, by the processor to an Evolved Node B (eNB), a Paging Radio Network Temporary Identifier (P-RNTI) filtering message.

2. The system as claimed in claim 1, wherein the at least one processor is configured to:
start, by the MME, a T3413 timer;
send, by the MME to the eNB, a Paging Control Channel (PCCH) paging message; and
send, by the eNB to a known mobile device, a Radio Resource Control paging message.

3. The system as claimed in claim 1, wherein to track the at least one of the TMSI, S-TMSI, GUTI, or c-RNTI comprises the at least one processor receiving device and location data from at least one of:
an Observed Time Difference of Arrival (OTDOA);
light detection and ranging (LIDAR); or
Channel State Information.

4. The system as claimed in claim 3, wherein device and location data received from the OTDOA include data pertaining to Fifth Generation low frequency bands (5G-FR1) and data pertaining to 5G high frequency bands (5G-FR2) mmWave.

5. A system for classifying detected mobile devices, the system comprising:
at least one processor; and
a memory storing instructions which when executed by the at least one processor configure the at least one processor to:
listen, by a processor, on an uplink channel for a detected mobile device;
receive, by the processor from the detected mobile device, capabilities information regarding the detected mobile device; and
obtain, by the processor from a database, a user equipment (UE) model of the detected mobile device, said UE model determined based on the capabilities information.

6. The system as claimed in claim 5, wherein the processor is configured to:
retrieve, by the processor from a database, the UE model based on the capabilities.

7. The system as claimed in claim 5, wherein the processor is configured to:
send, by an MME to an eNB, a request message for capabilities of the detected mobile device;
send, by the eNB to the detected mobile device, a capability enquiry request;
receive, by the eNB from the detected mobile device, the capabilities information; and
receive, by the MME from the eNB, the capabilities information.

8. The system as claimed in claim 5, wherein to receive includes the processor receiving device and location data from at least one of:
an OTDOA;
LIDAR; or
Channel State Information.

9. The system as claimed in claim 8, wherein device and location data received from the OTDOA include data pertaining to 5G-FR1 and data pertaining to 5G-FR2 mmWave.

10. A method of detecting mobile devices, the method comprising:
sending, by a processor, a soft page message via MSISDN to an MME;
tracking, by the processor, a TMSI/S-TMSI/GUTI/c-RNTI; and
sending, by the processor to an eNB, a P-RNTI filtering message.

11. The method as claimed in claim 10, comprising:
starting, by the MME, a T3413 timer;
sending, by the MME to the eNB, a PCCH-paging message; and
sending, by the eNB to a known mobile device, an RRC paging message.

12. The method of claim 10, wherein tracking includes receiving device and location data from at least one of:
an OTDOA;
LIDAR; or
Channel State Information.

13. The method of claim 12, wherein device and location data received from the OTDOA include data pertaining to 5G-FR1 and data pertaining to 5G-FR2 mmWave.

14. A method of classifying detected mobile devices, the method comprising:
listening, by a processor, on an uplink channel for a detected mobile device;
receiving, by the processor from the detected mobile device, capabilities information regarding the detected mobile device; and
obtaining, by the processor from a database, a UE model of the detected mobile device, said UE model determined based on the capabilities information.

15. The method as claimed in claim 14, comprising:
retrieving, by the processor from a database, the UE model based on the capabilities.

16. The method as claimed in claim 14, comprising:
sending, by an MME to an eNB, a request message for capabilities of the detected mobile device;
sending, by the eNB to the detected mobile device, a capability enquiry request;
receiving, by the eNB from the detected mobile device, the capabilities information; and
receiving, by the MME from the eNB, the capabilities information.

17. The method of claim 14, wherein receiving includes receiving device and location data from at least one of:
an OTDOA;
LIDAR; or
Channel State Information.

18. The method of claim 17, wherein device and location data received from the OTDOA include data pertaining to 5G-FR1 and data pertaining to 5G-FR2 mmWave.
